(19) United States
(12) Patent Application Publication
(10) Pub. No.: US 2024/0193482 A1
(43) Pub. Date: Jun. 13, 2024

(54) MUSIC RECOMMENDATIONS VIA CAMERA SYSTEM

(71) Applicant: Snap Inc., Santa Monica, CA (US)

(72) Inventors: Eric Portes dos Santos, Bothell, WA (US); Matthew Mahar, San Francisco, CA (US); Christie Marie Heikkinen, Sherman Oaks, CA (US); Anton Shevchenko, Black Diamond, WA (US); Hanbo Chen, Kirkland, WA (US); Xin Su, Santa Clara, CA (US)

(21) Appl. No.: 18/535,551

(22) Filed: Dec. 11, 2023

Related U.S. Application Data
(60) Provisional application No. 63/386,916, filed on Dec. 11, 2022.

(51) Int. Cl. G06N 20/00; G06T 11/00

(52) U.S. Cl. CPC G06N 20/00; G06T 11/00; G06T 2200/24

(57) ABSTRACT

A system includes one or more hardware processors and at least one memory storing instructions that cause the one or more hardware processors to perform operations including receiving, via a client device, a selection of a photographic filter or a virtual lens. The operations additionally include deriving, via a model, a date, or a combination thereof, a music recommendation, a sound recommendation, or a combination thereof, for the selection of the photographic filter or the virtual lens, and providing the music recommendation, the sound recommendation, or the combination thereof, to the client device.

### CROSS-REFERENCE TO RELATED APPLICATION

This patent application claims the benefit of U.S. Provisional Patent Application No. 63/386,916, filed Dec. 11, 2022, entitled “MUSIC RECOMMENDATIONS VIA CAMERA SYSTEM”, which is incorporated by reference herein in its entirety.

### BACKGROUND

Camera systems, such as a camera disposed on a mobile device, can capture a variety of electronic images and video. The popularity of image and video capture continues to grow. Users increasingly share media content items such as electronic images and videos with each other. Users also increasingly utilize their mobile devices to communicate with each other using message programs. For example, a user can create media content and share it via a message program.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

### BRIEF DESCRIPTION OF THE DRAWINGS

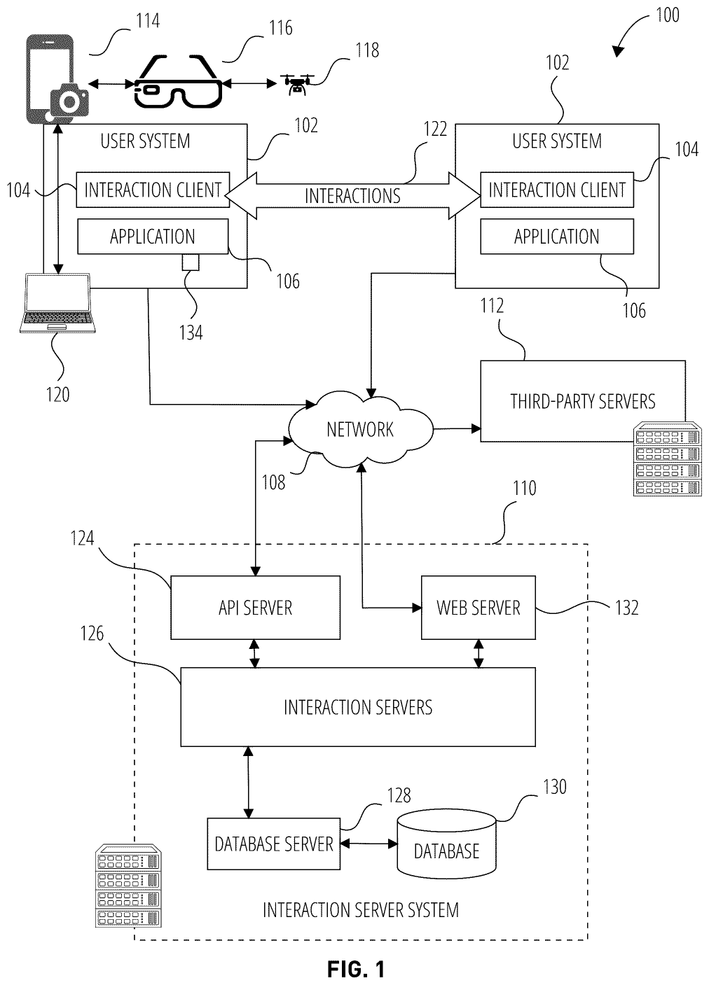

FIG. 1 is a diagrammatic representation of a networked environment in which the present disclosure may be deployed, according to some examples.

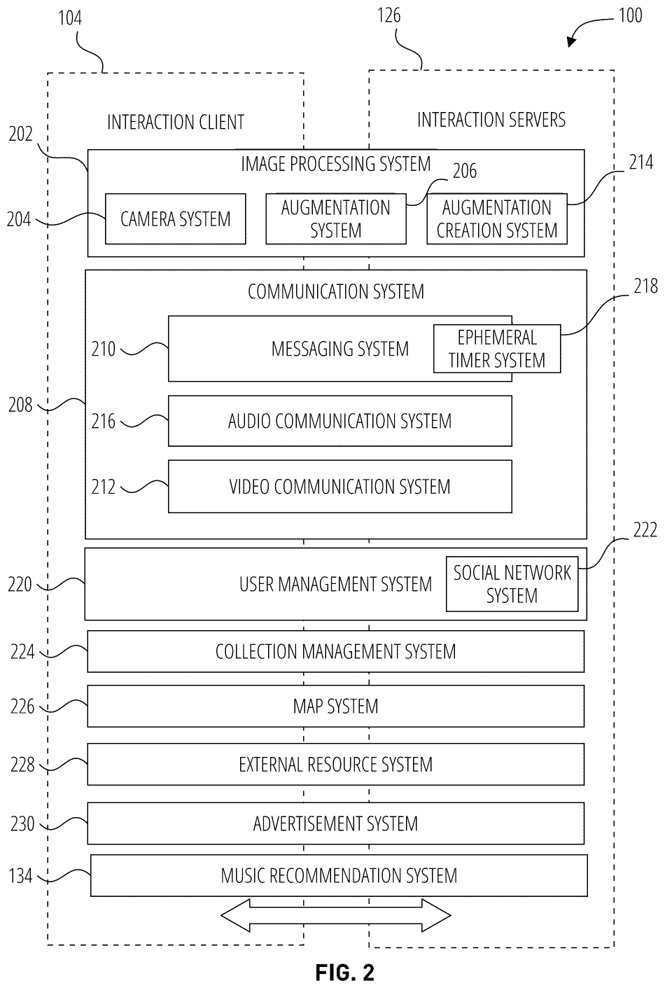

FIG. 2 is a diagrammatic representation of a messaging system, according to some examples, that has both client-side and server-side functionality.

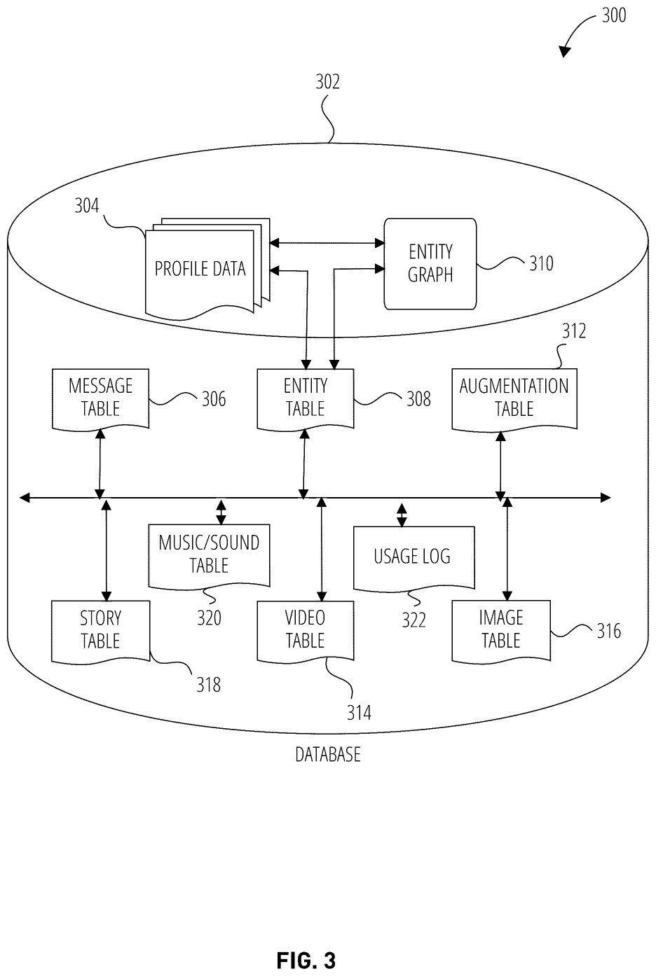

FIG. 3 is a diagrammatic representation of a data structure as maintained in a database, according to some examples.

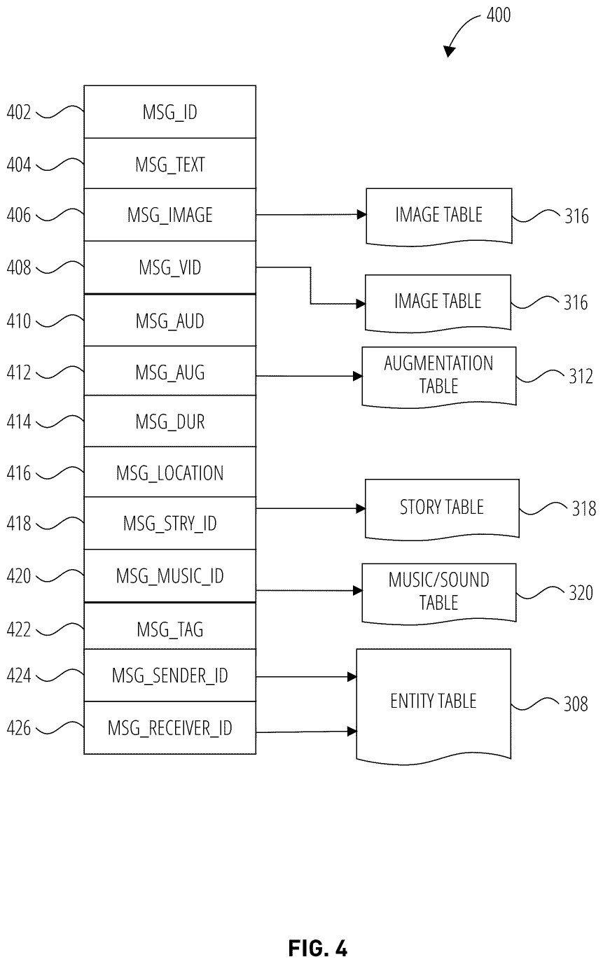

FIG. 4 is a diagrammatic representation of a message, according to some examples.

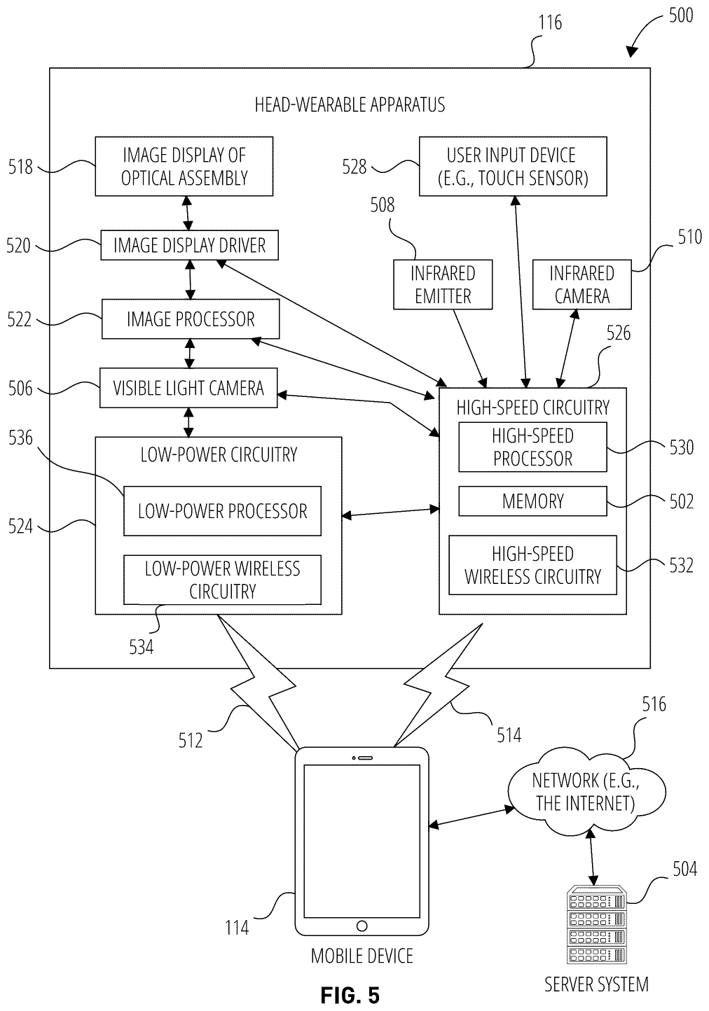

FIG. 5 illustrates a system in which the head-wearable apparatus, according to some examples.

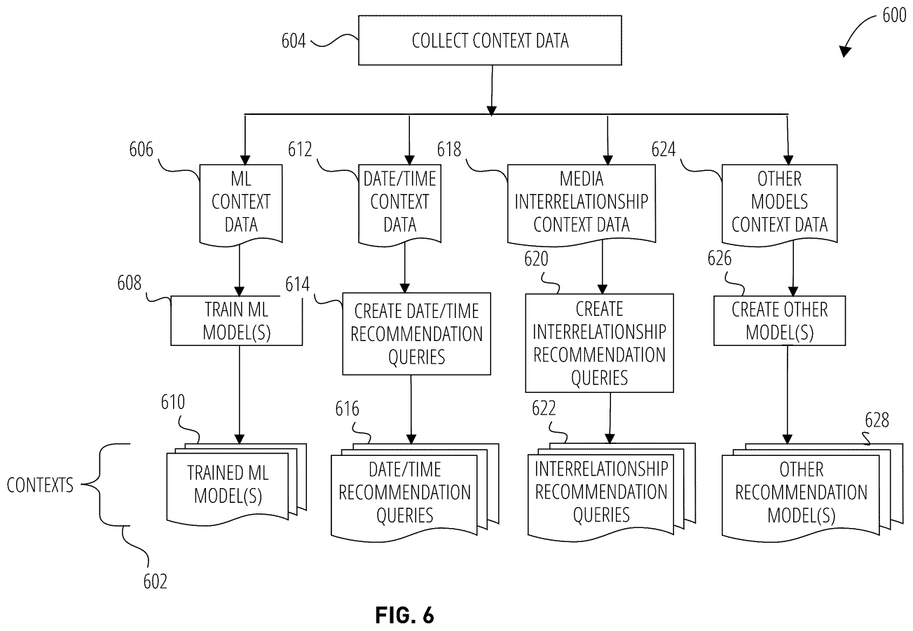

FIG. 6 illustrates a process for providing suggested music and sounds recommendations for a photographic filter and a visual lens, according to some examples.

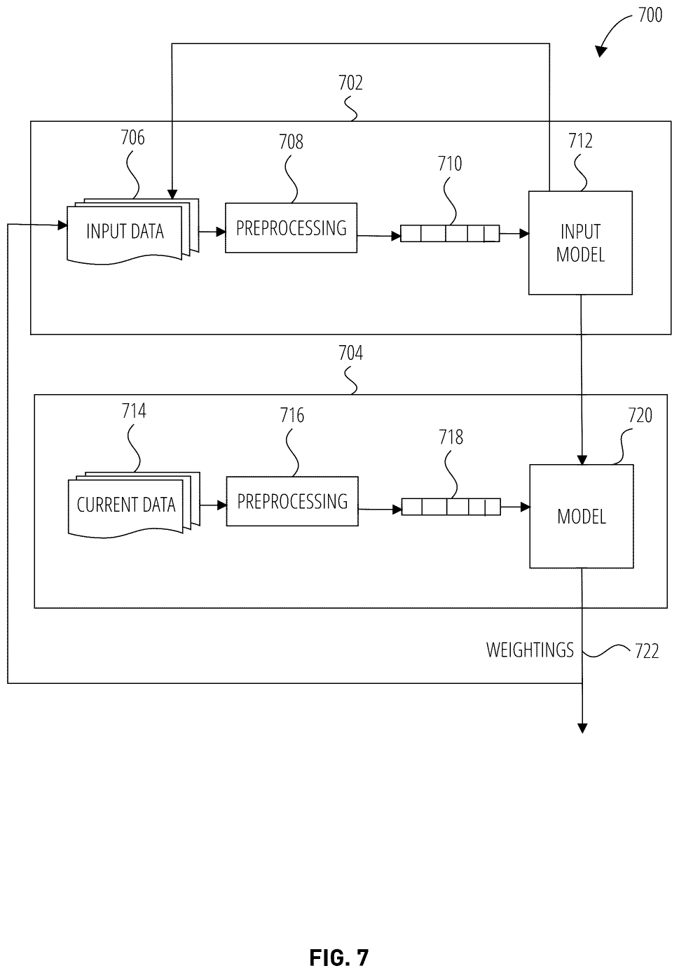

FIG. 7 illustrates a machine learning engine for creating and training machine learning (ML) models, according to some examples.

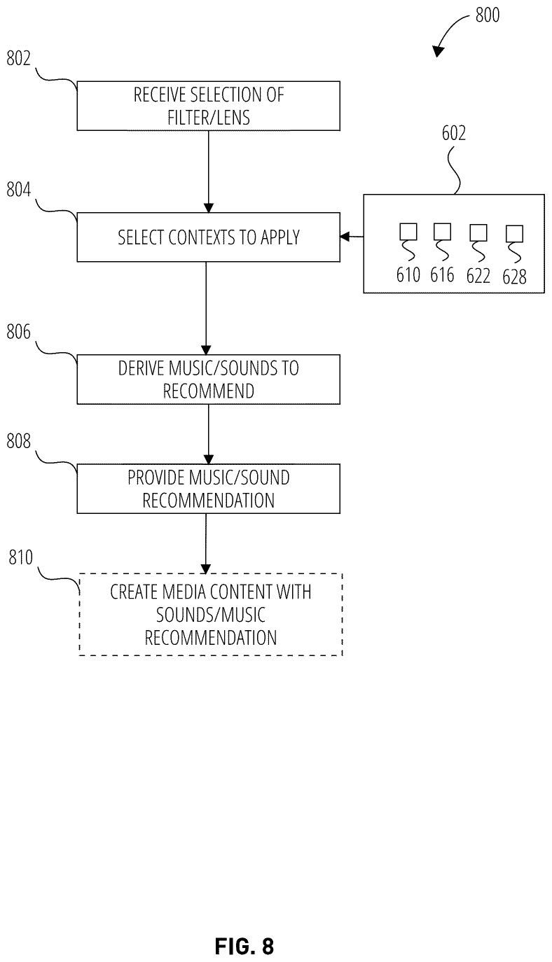

FIG. 8 providing suggested music and sounds recommendations for a photographic filter and a visual lens, according to some examples.

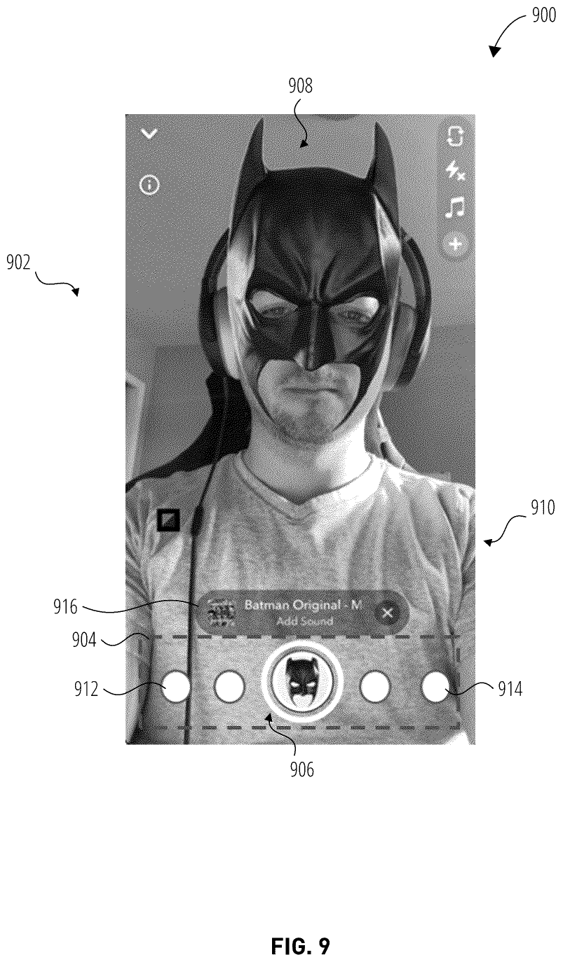

FIG. 9 is a screenshot of a display of a client device, according to some examples.

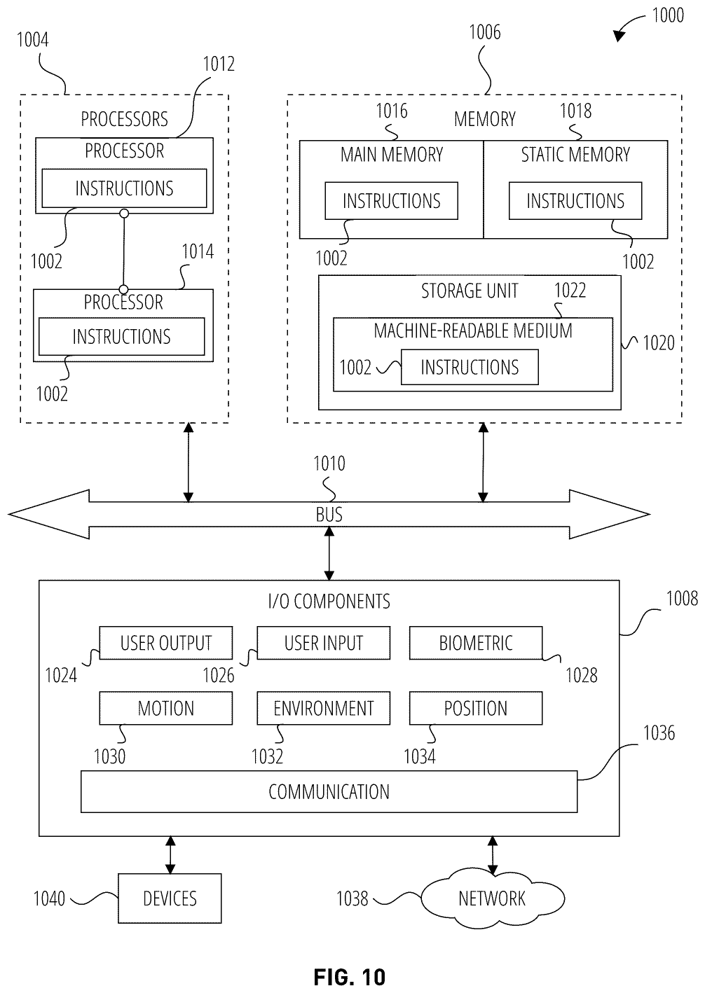

FIG. 10 is a diagrammatic representation of a machine in the form of a computer system within which a set of instructions may be executed to cause the machine to perform any one or more of the methodologies discussed herein, according to some examples.

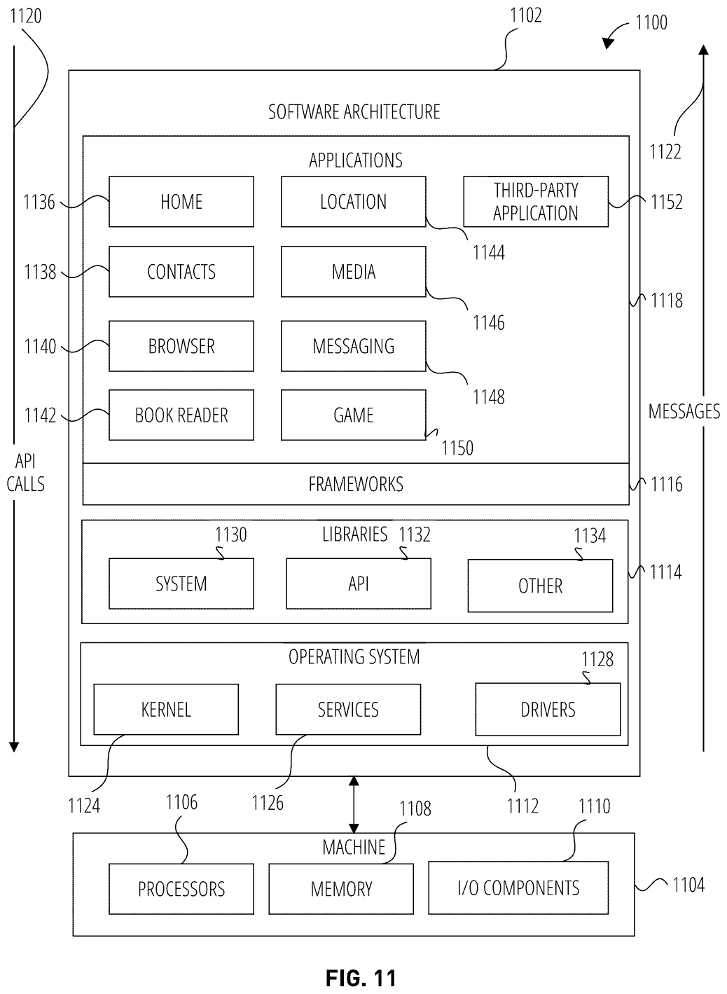

FIG. 11 is a block diagram showing a software architecture within which examples may be implemented.

### DETAILED DESCRIPTION

Camera systems are included in a variety of devices such as mobile devices, smart watches, drones, and so on. The camera systems enable a user to take images and video and are communicatively and/or operatively coupled to certain applications, such as messaging applications. In some examples, the messaging application enables a user to apply photographic filters and/or virtual lenses to transform the image and/or video with media overlays, augmented reality (AR) content, and/or virtual reality (VR) content. An AR experience includes the application of virtual content to a real-world environment whether through presentation of the virtual content by transparent displays through which a real-world environment is visible or through augmenting image data to include the virtual content overlaid on real-world environments depicted therein. VR experiences are also be provided, in which a completely simulated or virtual view of a world is presented through a display device. For example, when taking a selfie picture or a video, a user selects a filter or a virtual lens from a “carousel” having a selection of photographic filters and virtual lenses. The messaging application then displays certain media overlays, AR content, and/or VR content based on the selected photographic filter or virtual lens, thus adding to or modifying the user's image or video.

As used herein, a photographic filter provides for image overlays, including static overlays. For example, a user can take a picture of the Eiffel tower and superimpose a geolocation tag such as text indicating the country (e.g., France) and a French flag. A virtual lens can provide for AR content overlaid over the real world. For example, a user can take a selfie video and the virtual lens can apply virtual cat ears overlaid on the user's head. The virtual lens can also provide for the display of avatars, both in AR and in VR examples. For example, a user's avatar can be displayed dancing overlaid a current camera video capture, such as the avatar dancing on the user's table. Both photographic filters and virtual lenses use a camera system to capture images and transform the images via added overlays and/or image transformations (e.g., aging a user's face).

The techniques described herein provide for improved content creation and viewing by automatically recommending, and in some embodiments, automatically adding, music and sounds to media content produced via the photographic filters and/or virtual lenses based on the selected filter or virtual lens and one or more contexts. A context can include a machine learning model context, a date/time context, a media interrelationship context, and other model contexts. For example, certain machine learning (ML) models are trained and continuously updated to recognize correlations (e.g., correlative measures) between a selected filter or virtual lens and sounds that are being used to create or present media content produced by the selected filter or virtual lens.

In one ML context example, members of a social group (e.g., friends group) are creating media content by adding certain specific sounds (e.g., a song or playlist) to media content produced by a cat ears filter. An ML model detects the increasing use of the same song with the cat ears filter and when a user selects the cat ears filter the same song is presented. The ML model additionally can detect that user A likes content X more than user B, and can further customize recommendations based on user tastes. In certain date/time context examples, certain dates and/or times are used to present a selection of sounds when using the selected filter or virtual lens. For example, various dog-related songs, such as “Who Let the Dogs Out,” are presented to certain filters during national dog day. Likewise, a selection of holiday music is presented during certain data ranges around holidays. In certain media interrelationship context examples, interrelationships between media content and sounds are used. For example, when using a superhero filter (e.g., Batman), sounds or music associated with the superhero (e.g., Dark Knight soundtrack) are presented. Likewise, when using a dancing rapper avatar created via a virtual lens then music associated with the rapper is presented. In other model contexts, non-ML models, such as heuristic (e.g., probability) models, linear regression models, and so on, can be used to predict popular relationships between a filter/virtual lens and certain music. By contextually deriving relationships between sounds and filters/virtual lenses, the techniques described herein provide for a more efficient and engaging presentation of media content.

### Networked Computing Environment

It may be beneficial to describe certain systems that implement the techniques described herein. Turning now to FIG. 1, the figure is a block diagram showing an example interaction system 100 for facilitating interactions (e.g., exchanging text messages, conducting text audio and video calls, creating media content, or playing games) over a network. The interaction system 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, a drone 118, and a computer client device 120 that are communicatively connected to exchange data and messages. An interaction client 104 interacts with other interaction clients 104 and with the interaction server system 110 via the network 108. The data exchanged between the interaction clients 104 (e.g., interactions 122) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 124 is coupled to and provides programmatic interfaces to interaction servers 126, making the functions of the interaction servers 126 accessible to interaction clients 104, other applications 106 and third-party server 112. The interaction servers 126 are communicatively coupled to a database server 128, facilitating access to a database 130 that stores data associated with interactions processed by the interaction servers 126. Similarly, a web server 132 is coupled to the interaction servers 126 and provides web-based interfaces to the interaction servers 126. To this end, the web server 132 processes incoming network requests over the Hypertext Transfer Protocol (HTTP), remote procedure calls (RPC), and several other related protocols.

The Application Program Interface (API) server 124 receives and transmits interaction data (e.g., commands and message payloads) between the interaction servers 126 and the client systems 102 (and, for example, interaction clients 104 and other application 106) and the third-party server 112. Specifically, the Application Program Interface (API) server 124 provides a set of interfaces (e.g., routines and protocols) that can be called or queried by the interaction client 104 and other applications 106 to invoke functionality of the interaction servers 126. The Application Program Interface (API) server 124 exposes various functions supported by the interaction servers 126, including account registration; login functionality; the sending of interaction data, via the interaction servers 126, from a particular interaction client 104 to another interaction client 104; the communication of media files (e.g., images or video) from an interaction client 104 to the interaction servers 126; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

The application 106 includes a sound (e.g., music) recommendation system 134, which can also be included on one or more servers, that can recommend certain sounds based on the user selecting a photographic filter or a virtual lens. For example, the application 106 can provide a graphical user interface (GUI) control, such as a “carousel” or other controls (e.g., mouse controls, touch controls) displaying icons or text representative of photographic filters and virtual lenses. The icons are overlaid on a view of the camera (e.g., showing a selfie). The user can swipe to display additional icons. When an icon is selected, the sound recommendation system 134 then uses a machine learning (ML) context, a date/time context, a media interrelationship context, and/or other model contexts to recommend sounds for the user's selected photographic filter/virtual lens. In some examples, the ML context, date/time context, media interrelationship context, and other models context can be used separately or in combination. In some examples, the recommendations for each photographic filter or virtual lens have been preprocessed via the ML context, date/time context, media interrelationship context, and other models context. That is, the ML context, date/time context, media interrelationship context, and other models context can be used before the user selection of the photographic filter or virtual lens to match the photographic filter or virtual lens with music and/our sounds and have recommendations already derived. For example, daemon jobs or similar processing can be used to execute the ML context, date/time context, media interrelationship context, and other models context every minute, hour, day, week, or combination thereof, to have recommendations ready for presentation when the user selects a photographic filter or virtual lens.

In some examples, the ML context will provide trained ML model(s) with current data, such as “friends” data, geolocation data, and/or social networking data, and the ML model(s) will then output recommendations of sounds to match the selected photographic filter/virtual lens. Likewise, the other models context will provide non-ML model(s), such as heuristic models, linear regression analysis models, and the like, with similar or the same data used by the ML model(s), e.g., “friends” data, geolocation data, and/or social networking data, and the non-ML model(s) will then output recommendations of sounds to match the selected photographic filter/virtual lens. In the date/time context, one or more date/time queries are executed via the database server 128 to derive the recommended one or more sounds for the selected photographic filter/virtual lens. In the media interrelationship context, one or more media interrelationship queries are executed via the database server 128 to derive the recommended one or more sounds for the selected photographic filter/virtual lens. As mentioned earlier, recommendations from the contexts can be combined, and additionally used to find which recommendation is “best.” The recommended sounds can then be incorporated into certain messages, such as a “story” that the user is creating via a camera system. The story with the recommended sound and media overlays are then distributed to other user systems 102, for example, via the interaction servers 126. The interaction servers 126 host multiple systems and subsystems, including a server-side sound recommendation system, as described in more detail below with reference to FIG. 2.

### System Architecture

FIG. 2 is a block diagram illustrating further details regarding the interaction system 100, according to some examples. Specifically, the interaction system 100 is shown to comprise the interaction client 104 and the interaction servers 126. The interaction system 100 embodies multiple subsystems, which are supported on the client-side by the interaction client 104 and on the server-side by the interaction servers 126. Example subsystems are discussed below.

An image processing system 202 provides various functions that enable a user to capture and augment (e.g., annotate or otherwise modify or edit) media content associated with a message, for example, using media content captured via a camera system 204. The camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., created via a photographic filter or a virtual lens) to the interaction client 104 for the augmentation of real-time images received via the camera system 204 or stored images retrieved from memory 502 of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 130 and accessed through the database server 128.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles, and includes a social network system 222 that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the user interface of the interaction client 104. The collection management system 224 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 224 employs machine vision (or image recognition technology) and content rules to curate a content collection automatically. In certain examples, compensation may be paid to a user to include user-generated content into a collection. In such cases, the collection management system 224 operates to automatically make payments to such users to use their content.

A map system 226 provides various geographic location functions and supports the presentation of map-based media content and messages by the interaction client 104. For example, the map system 226 enables the display of user icons or avatars (e.g., stored in profile data 304) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

An external resource system 228 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 126. The SDK includes Application Programming Interfaces (APIs) with functions that can be called or invoked by the web-based application. The interaction servers 126 host a JavaScript library that provides a given external resource access to specific user data of the interaction client 104. HTML5 is an example of technology for programming games, but applications and resources programmed based on other technologies can be used.

As mentioned above, the music recommendation system 134 provides sound (e.g., music) recommendations via various contexts. For example, the ML context will provide trained ML model(s) with current data, such as “friends” data, geolocation data, and/or social networking data, and the ML model(s) will then output recommendations of sounds to match the selected photographic filter/virtual lens. Likewise, the other models context will provide non-ML model(s), such as heuristic (e.g., probability models), linear regression analysis models, and the like, with similar or the same data used by the ML model(s), e.g., “friends” data, geolocation data, and/or social networking data, and the non-ML model(s) will then output recommendations of sounds to match the selected photographic filter/virtual lens. In the date/time context, one or more date/time queries are executed via the database server 128 to derive the recommended one or more sounds for the selected photographic filter/virtual lens. In the media interrelationship context, one or more media interrelationship queries are executed via the database server 128 to derive the recommended one or more sounds for the selected photographic filter/virtual lens.

The recommended sounds can then be incorporated into certain messages, such as a “story” that the user is creating via the camera system 204. In certain examples, the music recommendation system 134 is included in the augmentation system 206, or is operatively coupled to the augmentation system 206. Accordingly, the augmentation system 206 presents recommended sounds/music when the user selects a photographic filter/virtual lens to use via the augmentation system 206. In certain examples, the music recommendation system 134 is additionally or alternatively included in the augmentation creation system 214 or operatively coupled to the augmentation creation system 214. Accordingly, content creators (e.g., artists and developers) can use the sound recommendation contexts (e.g., ML models, non-ML models, date/time recommendation queries, media interrelationship recommendation queries) via APIs and/or object calls to create and publish augmentations (e.g., augmented reality experiences) that can incorporate sound recommendations.

To integrate the functions of the SDK into the web-based resource, the SDK is downloaded by the third-party server 112 from the interaction servers 126 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 126. The interaction servers 126 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth. An advertisement system 230 operationally enables the purchasing of advertisements by third parties for presentation to end-users via the interaction clients 104 and also handles the delivery and presentation of these advertisements.

### Data Architecture

FIG. 3 is a schematic diagram illustrating data structures 300, which may be stored in the database 302 of the interaction server system 110, according to certain examples. While the content of the database 302 is shown to comprise multiple tables, it will be appreciated that the data could be stored in other types of data structures (e.g., as an object-oriented database).

The database 302 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 304. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 304 stores multiple types of profile data about a particular entity. The profile data 304 may be selectively used and presented to other users of the interaction system 100 based on privacy settings specified by a particular entity. Where the entity is an individual, the profile data 304 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 304 for the group may similarly include one or more avatar representations associated with the group, in addition to the group name, members, and various settings (e.g., notifications) for the relevant group. The database 302 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

The databases 302 also include a music/sound table 320 storing licensed music and other sounds. Music may include vocal and/or instrumental songs, portions of songs (e.g., song snippets), and the like. Sounds include nature sounds, white noise sounds, or any other vibratory noise capturable via a microphone. The music/sound table 320 includes names of music and sounds, descriptions of music and sounds, as well as the actual music/sounds or links to the music/sounds.

A usage log 322 is also depicted. The usage log 322 captures anonymized information (e.g., information that has user identification removed, for example, to comply with jurisdictional laws and regulations) for music/sounds being played, as well as any filter/virtual lens that is being used during music/sound playback. The usage log 322 also captures anonymized geolocation data of locations where the music/sound playback occurs, number of times the music/sound playback occurs, and the like.

### Data Communications Architecture

FIG. 4 is a schematic diagram illustrating a structure of a message 400, according to some examples, generated by an interaction client 104 for communication to a further interaction client 104 via the interaction servers 126. The content of a particular message 400 is used to populate the message table 306 stored within the database 302, accessible by the interaction servers 126. Similarly, the content of a message 400 is stored in memory as “in-transit” or “in-flight” data of the user system 102 or the interaction servers 126. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the story table 318) with which a particular content item in the message image payload 406 of the message 400 is associated. For example, multiple images within the message image payload 406 may each be associated with multiple content collections using identifier values.
Message music identifier 420: identifier values identifying one or more music or sounds with to recommend and/or play with certain message augmentation data 412 (e.g., photographic filters, stickers, or other annotations or enhancements).
Message tag 422: each message 400 may be tagged with multiple tags, each of which is indicative of the subject matter of content included in the message payload. For example, where a particular image included in the message image payload 406 depicts an animal (e.g., a lion), a tag value may be included within the message tag 422 that is indicative of the relevant animal. Tag values may be generated manually, based on user input, or may be automatically generated using, for example, image recognition.
Message sender identifier 424: an identifier (e.g., a messaging system identifier, email address, or device identifier) indicative of a user of the user system 102 on which the message 400 was generated and from which the message 400 was sent.
Message receiver identifier 426: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a story table 318, and values stored within the message sender identifier 424 and the message receiver identifier 426 may point to user records stored within an entity table 308.

### System with Head-Wearable Apparatus

FIG. 5 illustrates a system 500 including a head-wearable apparatus 116 with a selector input device, according to some examples. FIG. 5 is a high-level functional block diagram of an example head-wearable apparatus 116 communicatively coupled to a mobile device 114 and various server systems 504 (e.g., the interaction server system 110) via various networks 108.

The head-wearable apparatus 116 includes one or more cameras, each of which may be, for example, a visible light camera 506, an infrared emitter 508, and an infrared camera 510.

The mobile device 114 connects with head-wearable apparatus 116 using both a low-power wireless connection 512 and a high-speed wireless connection 514. The mobile device 114 is also connected to the server system 504 and the network 516.

The head-wearable apparatus 116 further includes two image displays of the image display of optical assembly 518. The two image displays of optical assembly 518 include one associated with the left lateral side and one associated with the right lateral side of the head-wearable apparatus 116. The head-wearable apparatus 116 also includes an image display driver 520, an image processor 522, low-power circuitry 524, and high-speed circuitry 526. The image display of optical assembly 518 is for presenting images and videos, including an image that can include a graphical user interface to a user of the head-wearable apparatus 116.

The image display driver 520 commands and controls the image display of optical assembly 518. The image display driver 520 may deliver image data directly to the image display of optical assembly 518 for presentation or may convert the image data into a signal or data format suitable for delivery to the image display device. For example, the image data may be video data formatted according to compression formats, such as H.264 (MPEG-4 Part 10), HEVC, Theora, Dirac, Real Video RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 528 (e.g., touch sensor or push button), including an input surface on the head-wearable apparatus 116. The user input device 528 (e.g., touch sensor or push button) is to receive from the user an input selection to manipulate the graphical user interface of the presented image.

The components shown in FIG. 5 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 506 can include digital camera elements such as a complementary metal oxide-semiconductor (CMOS) image sensor, charge-coupled device, camera lenses, or any other respective visible or light-capturing elements that may be used to capture data, including images of scenes with unknown objects. The head-wearable apparatus 116 includes a memory 502, which stores instructions to perform a subset or all of the functions described herein. The memory 502 can also include storage device.

As shown in FIG. 5, the high-speed circuitry 526 includes a high-speed processor 530, a memory 502, and high-speed wireless circuitry 532. In some examples, the image display driver 520 is coupled to the high-speed circuitry 526 and operated by the high-speed processor 530 in order to drive the left and right image displays of the image display of optical assembly 518. The high-speed processor 530 may be any processor capable of managing high-speed communications and operation of any general computing system needed for the head-wearable apparatus 116. The high-speed processor 530 includes processing resources needed for managing high-speed data transfers on a high-speed wireless connection 514 to a wireless local area network (WLAN) using the high-speed wireless circuitry 532. In certain examples, the high-speed processor 530 executes an operating system such as a LINUX operating system or other such operating system of the head-wearable apparatus 116, and the operating system is stored in the memory 502 for execution. In addition to any other responsibilities, the high-speed processor 530 executing a software architecture for the head-wearable apparatus 116 is used to manage data transfers with high-speed wireless circuitry 532. In certain examples, the high-speed wireless circuitry 532 is configured to implement Institute of Electrical and Electronic Engineers (IEEE) 802.11 communication standards, also referred to herein as WiFi. In some examples, other high-speed communications standards may be implemented by the high-speed wireless circuitry 532.

The low-power wireless circuitry 534 and the high-speed wireless circuitry 532 of the head-wearable apparatus 116 can include short-range transceivers (Bluetooth™) and wireless wide, local, or wide area network transceivers (e.g., cellular or WiFi). Mobile device 114, including the transceivers communicating via the low-power wireless connection 512 and the high-speed wireless connection 514, may be implemented using details of the architecture of the head-wearable apparatus 116, as can other elements of the network 516.

The memory 502 includes any storage device capable of storing various data and applications, including, among other things, camera data generated by the left and right visible light cameras 506, the infrared camera 510, and the image processor 522, as well as images generated for display by the image display driver 520 on the image displays of the image display of optical assembly 518. While the memory 502 is shown as integrated with high-speed circuitry 526, in some examples, the memory 502 may be an independent standalone element of the head-wearable apparatus 116. In certain such examples, electrical routing lines may provide a connection through a chip that includes the high-speed processor 530 from the image processor 522 or the low-power processor 536 to the memory 502. In some examples, the high-speed processor 530 may manage addressing of the memory 502 such that the low-power processor 536 will boot the high-speed processor 530 any time that a read or write operation involving memory 502 is needed.

As shown in FIG. 5, the low-power processor 536 or high-speed processor 530 of the head-wearable apparatus 116 can be coupled to the camera (visible light camera 506, infrared emitter 508, or infrared camera 510), the image display driver 520, the user input device 528 (e.g., touch sensor or push button), and the memory 502. The head-wearable apparatus 116 is connected to a host computer. For example, the head-wearable apparatus 116 is paired with the mobile device 114 via the high-speed wireless connection 514 or connected to the server system 504 via the network 516. The server system 504 may be one or more computing devices as part of a service or network computing system, for example, that includes a processor, a memory, and network communication interface to communicate over the network 516 with the mobile device 114 and the head-wearable apparatus 116.

The mobile device 114 includes a processor and a network communication interface coupled to the processor. The network communication interface allows for communication over the network 516, low-power wireless connection 512, or high-speed wireless connection 514. Mobile device 114 can further store at least portions of the instructions for generating binaural audio content in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 520. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 504, such as the user input device 528, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 512 and high-speed wireless connection 514 from the mobile device 114 via the low-power wireless circuitry 534 or high-speed wireless circuitry 532. The head-wearable apparatus 116 is used to capture and/or display media content, including media created by the augmentation system 206 and music/sound recommendations provided by the music recommendation system 134.

FIG. 6 illustrates a process 600 for creating certain machine executable contexts 602 that can provide music and sound recommendations, according to one example. In the depicted example, the process 600 collects, at block 604, certain context data. For example, a machine learning (ML) context data 606 may include data suitable for training, at block 608, one or more ML models 610 to output music/sound recommendations based on using a photographic filter or virtual lens as input. For example, the ML context data 606 includes, for every use of a photographic filter and virtual lens, the music or sound selection, if any, that a user has selected to pair with the photographic filter or the virtual lens. The ML context data 606 can include a date/time for the pairing of the photographic filter of the virtual lens with the music or sound selecting, how many times the music or sound has been selected, the user that selected the music or sound, geolocation information, a type of camera used (e.g., mobile phone camera, webcam), a type of device used (e.g., mobile phone, smart watch), friends that have used the pairing, and the like. Further details of the creation and training of the trained ML model(s) 610 is described below with respect to FIG. 7.

The process 600 also uses a date/time context data 612 to create, at block 614, one or more date/time recommendation queries 616. For example, the date/time context data 612 includes a calendar of holidays, a calendar of national days (e.g., national cat day falls on October 28 annually), a calendar of international days (e.g., international day of friendship falls on July 30), a calendar of events (e.g., local festivals, including music festivals, concerts, local celebrations, parades, and the like), which is stored in the database 130. In some examples, date/time recommendation queries 616 can be created, at block 614, by determining a date/time of interest and the querying the database 130 for corresponding holidays, national days, international days, and events. A second date/time recommendation query 616 can then be created to use as a query term unique IDs (or names) for the corresponding holidays, national days, international days, and events. The second date/time recommendation query 616 can then find, via the music/sound table 320, music and sounds associated with the holidays, national days, international days, and events. Indeed, the music/sound table 320 (or related tables) can include searchable column(s) that map each music or song stored to one or more holidays, national days, international days, and events.

Media interrelationship context data 618 includes data that relates a photographic filter or a virtual lens to certain associated music and sounds. For example, a superhero, such as Batman, can be associated with Batman movie soundtracks, bat noises, cave echo noises, and so on. Accordingly, the music/sound table 320 (and associated tables) can store column(s) that map each photographic filter or virtual lens to one or more music and sounds. An interrelationship recommendation query 622 is created, at block 620, to use as a query term unique IDs for the photographic filter or virtual lens to retrieve the media interrelated music and sounds.

Other models context data 624 includes data that is used to create, at block 626, other recommendation models 628, such as non-ML models that use linear regression, heuristic derivations (e.g., Bayesian inference), and so on. In some examples, the other models context data 624 includes the same or similar data to the ML context data 606, such as, for every use of a photographic filter and virtual lens, the music or sound selection, if any, that a user has selected to pair with the photographic filter or the virtual lens. The other models context data 624 can also include a date/time for the pairing of the photographic filter of the virtual lens with the music or sound selecting, how many times the music or sound has been selected, geolocation information, a type of camera used (e.g., mobile phone camera, webcam), a type of device used (e.g., mobile phone, smart watch), friends that have used the pairing, and the like. The other recommendation models 628 can be created, at block 626, by linear regression analysis (e.g., setting a dependent variable as the photographic filter and the virtual lens) of the other models context data 624 to derive one or more equations that take as input a selected photographic filter or virtual lens and produce as output a song, song snippet, and sounds to recommend. Likewise, heuristic analysis via, for example, Bayesian probability analysis (e.g., using prior probability distributions of the photographic and virtual lens selection) can also be used to derive one or more equations that take as input a selected photographic filter or virtual lens and produce as output a song, song snippet, and sounds to recommend.

As mentioned earlier, the each of the contexts 602 can be used alone or in combination to provide music and/or sound recommendations. That is, recommendations from the contexts 602 can be combined, and additionally used to find which recommendation is “best.” In some examples, the music and/or sound recommendations are ranked, for example, from most recommended to least recommended. ML recommendations may be ranked via “weightings” as further described below. For date/time recommendation queries 616 and media interrelationship recommendation queries 622, a popularity ranking field in the music/sound table 320 may be used to determine most popular holiday music, national day music, and so on. For other models 628, each model may include metrics that rank predictive output (e.g., recommended music and sounds), such as multiple R-squared metrics, adjusted R-squared metrics, and so on. Likewise, statistical models, such as Bayesian-based models, include metrics such as relative probabilities, that can then be used for rankings. It is also to be noted that the contexts 602 can be used to rank recommendations such that an individual user's likes are taken into account. Models 610 can be trained do identify that user A likes content X more than user B, and or more than context Y. Similarly, the queries 616, 622, and other models 628 can be created to further customize recommendations based on individual user tastes.

FIG. 7 illustrates a machine learning engine for creating and training the trained ML models 610, in accordance with some embodiments. The machine learning engine may be deployed to execute at a computing system such as the interaction servers 126 server system 504 and/or the third-party servers 112. Indeed, a variety of computing systems may create and train the ML models 610, as further described below.

The machine learning engine 700 uses a training engine 702 and a prediction engine 704. Training engine 702 uses, for example, as input data 706, a subset of the ML context data 606. That is, the ML context data 606 is used to provide for a training input data 706. As mentioned earlier, the ML context data 606 can include, for every use of a photographic filter and virtual lens, the music or sound selection, if any, that a user has selected to pair with the photographic filter or the virtual lens. The ML context data 606 can also include a date/time for the pairing, geolocation information, a type of camera used (e.g., mobile phone camera, webcam), a type of device used (e.g., mobile phone, smart watch), and the like, as part of the input data 706.

The input data 706 is preprocessed via a preprocessing component 708, to determine one or more features 710. For example, the preprocessing component 708 can select a subset of relevant attributes or features in the input data 706 for predictive modeling. In one example, the features 710 that can be selected, include, a given photographic filter or virtual lens, the music or sounds previously used with the photographic filter or virtual lens, the number of times the music or sound was used with the photographic filter or virtual lens, the date/times of use, the geolocation for each use, the camera type for each use, and/or the device type for each so. The one or more features 710 may be used to generate an initial input model 712, which may be updated iteratively or with future labeled or unlabeled data (e.g., during reinforcement learning).

In the prediction engine 704, current data 714 (e.g., current ML context data 606 such as data that was logged the same day as the prediction engine 704 is used, the same week as the prediction engine 704 is used, and the like) may be input to preprocessing component 716. In some examples, preprocessing component 716 and preprocessing component 708 are the same. The prediction engine 704 produces feature vector 718 from the preprocessed current data, which is input into the model 720 to generate one or more criteria weightings 722. The criteria weightings 722 may be used to output a prediction, as discussed further below.

The training engine 702 may operate in an offline manner to train the model 720 (e.g., on a server). The trained model 720 thus becomes a trained ML model 610. The prediction engine 704 may be designed to operate in an online manner (e.g., in real-time, at a server, at a mobile device, on a wearable device, etc.). In some examples, the model 720 may be periodically updated via additional training (e.g., via updated input data 706 or based on labeled or unlabeled data output in the weightings 722) or based on identified future data, such as by using reinforcement learning to personalize a general model (e.g., the initial model 712) to a particular user. The initial model 712 may be updated using further input data 706 until a satisfactory model 720 is generated. The model 720 generation may be stopped according to a specified criteria (e.g., after sufficient input data is used, such as 1,000, 10,000, 700,000 data points, etc.) or when data converges (e.g., similar inputs produce similar outputs). The model 720 can be continuously evolved by training with newer data, daily, weekly, and so on.

The specific machine learning algorithm used for the training engine 702 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 702. In an example embodiment, a regression model is used and the model 720 is a vector of coefficients corresponding to a learned importance for each of the features in the vector of features 710, 718. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 720 receives as input a photographic filter or virtual lens and provides as output music and/or sound recommendations. In some examples, the music and/or sound recommendations are ranked, for example, from most recommended to least recommended. By training the model 720 into a trained ML model 610, the techniques described herein provide for music and sound recommendations that are derived from patterns found in the selections of music or sounds to include with certain photographic filters and virtual lenses.

FIG. 8 depicts an embodiment of a process 800 suitable for providing suggested music and sounds recommendations for a photographic filter and a visual lens, according to some examples. In the depicted example, the process 600 receives, at block 802, a selection of a photographic filter or a virtual lens. For example, the user of the user system 102 can select, via a GUI, a photographic filter or a visual lens to use. The process 800 then selects, at block 804, one or more contexts to apply to the selected photographic filter or visual lens. As mentioned above, ML models 610, date/time recommendation queries 616, media interrelationship recommendation queries 622, and/or other models 628 (e.g., non-ML models) can be used.

In some examples, the ML models 610 are a default choice. During certain “flagged” dates, such as Diwali, New Years, Chinese New Year, Christmas, and so on, the date/time recommendation queries 616 are used. In some examples, the media interrelationship recommendation queries 622 are used when events include new movie releases, concerts, parades, and so on, that include certain artists, movie characters, and so on. For example, during Oscars week, photographic filters and virtual lenses associated with movie characters, artists, and so on, can be matched with certain music/sound recommendations via the media interrelationship recommendation queries 622. The other models 628 can be used when training data is more limited, or to use fewer computing resources. In some examples, the ML models 610, date/time recommendation queries 616, media interrelationship recommendation queries 622, and other models 628 are all used.

The process 800 then derives, at block 806, one or more songs (e.g., vocal and instrumental music), song snippets, and sounds, to recommend, by applying the ML models 610, date/time recommendation queries 616, media interrelationship recommendation queries 622, and/or other models 628. Input into the ML models 610, date/time recommendation queries 616, media interrelationship recommendation queries 622, and other models 628 is the selected photographic filer or virtual lens. The output of the ML models 610, date/time recommendation queries 616, media interrelationship recommendation queries 622, and/or other models 628. Input into the ML models 610, date/time recommendation queries 616, media interrelationship recommendation queries 622, and other models 628 include one or more recommended songs, song snippets, and sounds.

The process 800 provides, at block 808, recommended music and/or sounds, e.g., the songs, song snippets, and sounds outputted via the ML models 610, date/time recommendation queries 616, media interrelationship recommendation queries 622, and/or other models 628. In some examples, a single recommended music or sound, e.g., a single song, song snippet, or sound. The single recommended music or sound is selected by determining the highest recommended music or sound. For ML models 610, in one example, weightings 722 may be used to rank recommendations from highest to lowest. For date/time recommendation queries 616 and media interrelationship recommendation queries 622, a popularity ranking field in the music/sound table 320 may be used to determine most popular holiday music, national day music, and so on. For other models 628, each model may include metrics that rank predictive output (e.g., recommended music and sounds), such as multiple R-squared metrics, adjusted R-squared metrics, and so on. Likewise, statistical models, such as Bayesian-based models, include metrics such as relative probabilities. The recommendation(s) are then transmitted, if server-derived, to the user system 102 to be displayed by a GUI as further described below.

In some examples, the recommended music and sounds is used to create, at block 810, media content. For example, the recommended music and sound may play automatically when the user is using the photographic filter or virtual lens. The techniques described herein thus provide for a more efficient and engaging ways of contextually matching media created via photographic filters and virtual lenses with a variety of music and sounds.

FIG. 9 illustrates an example screenshot 900 created via a GUI 902. In the depicted example, a carousel GUI control 904 displays a center icon 906 representative of a selected virtual lens. Accordingly, the virtual lens is used to create an AR augmentation, in this case a hood augmentation 908 displayed as “worn” by a user 910. The user 910 can turn their head around and the hood augmentation 908 will conform to the user's head as the head turns in a variety of angles and positions. If the user wishes other virtual lenses, the user can select other virtual lenses 912, 914. The carousel control 904 can take as input swipe gestures to present additional virtual lenses or photographic filters.

A music recommendation 916 is shown as displayed alongside the center icon 906. The music recommendation 916 can be derived by using the ML models 610, date/time recommendation queries 616, media interrelationship recommendation queries 622, and/or other models 628. The user can then add the music recommendation 916 to a message or a story to be transmitted, for example, to members of a social network. More specifically, the music recommendation 916, such as a song, a song snippet, and/or sounds, can be played alongside the display of the hood augmentation 908 as the user 910 records themselves and provides the recording to members of the social network.

### Machine Architecture

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies (e.g., processes 600, 800) discussed herein. The machine 1000, for example, may comprise the user system 102 or any one of multiple server devices forming part of the interaction server system 110. In some examples, the machine 1000 may also comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that execute the instructions 1002. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1030 include acceleration sensor components (e.g., accelerometer), gravitation sensor components, rotation sensor components (e.g., gyroscope).

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1034 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth™ components (e.g., Bluetooth™ Low Energy), Wi-FiR components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

### CONCLUSION

Technical advantages include automatically deriving music and sound recommendations by selecting a photographic filter or a virtual lens. The music and sound recommendations are contextual, providing for recommendations based on date/times, based on machine learning models, based on interrelationships between media, based on non-machine learning models, or a combination thereof. For example, photographic filters and virtual lenses in combination with certain music may be proving popular as part of a friends group, and the machine learning model can detect the popularity and aid a user to participate in the new trend.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software Accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall Accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A system, comprising:
one or more hardware processors; and
at least one memory storing instructions that cause the one or more hardware processors to perform operations comprising:
receiving, via a client device, a selection of a photographic filter or a virtual lens;
deriving, via a model, a date, or a combination thereof, a music recommendation, a sound recommendation, or a combination thereof, for the selection of the photographic filter or the virtual lens; and
providing the music recommendation, the sound recommendation, or the combination thereof, to the client device.

2. The system of claim 1, wherein the model comprises a machine learning model.

3. The system of claim 2, wherein the instructions comprise instructions that cause the one or more hardware processors to perform operations comprising training the machine learning model on a training data set.

4. The system of claim 3, wherein the training data set comprises a number of times that a song, a song snippet, a sound, or a combination thereof, is selected to be played alongside the photographic filter, the virtual lens, or a combination thereof.

5. The system of claim 4, wherein the training data set comprises a geographic location where the song, the song snippet, or the combination thereof, was played alongside the photographic filter, the virtual lens, or the combination thereof.

6. The system of claim 5, wherein the training data set comprises the number of times that the song, the song snippet, the sound, or a combination thereof, is selected by members of a social network to be played alongside the photographic filter, the virtual lens, or the combination thereof.

7. The system of claim 6, wherein the members of the social network comprise a friends group of a user of the client device.

8. The system of claim 3, wherein training the machine learning model comprises continuously training the machine learning model by using a current data set.

9. The system of claim 1, wherein the model comprises a linear regression model configured to apply a linear regression derivation or a probability-based model configured to apply a statistical probability derivation to derive the music recommendation, the sound recommendation, or the combination thereof.

10. The system of claim 1, wherein deriving via the date the music recommendation, the sound recommendation, or the combination thereof, comprises executing a first query to determine holiday, a national day, an international day, an event, or a combination thereof.

11. The system of claim 10, wherein deriving via the date the music recommendation, the sound recommendation, or the combination thereof, comprises executing a second query using results from the first query to determine music, sounds, or a combination thereof, associated with the holiday, the national day, the international day, the event, or the combination thereof.

12. The system of claim 1, wherein the instructions for deriving, via the model, the date, or the combination thereof, the music recommendation, the sound recommendation, or the combination thereof, for the selection of the photographic filter or the virtual lens, comprise instructions for deriving, via a media interrelationship recommendation query, the model, the date, or a combination thereof, the music recommendation, the sound recommendation, or the combination thereof, for the selection of the photographic filter or the virtual lens.

13. The system of claim 12, wherein the media interrelationship recommendation query is configured to determine music, sounds, or a combination thereof, associated with the photographic filter or with the virtual lens.

14. The system of claim 1, wherein the photographic filter is configured to position a media overlay on an image captured by a camera system.

15. The system of claim 1, wherein the virtual lens is configured to position an augmented reality (AR) content on an image captured by a camera system.

16. The system of claim 1, wherein the client device is configured to display a graphical user interface providing a carousel control for the selection of the photographic filter or of the virtual lens.

17. The system of claim 16, wherein the carousel control comprises an icon comprising a visual representation of the photographic filter or of the virtual filter, and wherein the music recommendation, the sound recommendation, or the combination thereof, is displayed alongside the icon.

18. A method, comprising:
receiving, from a client device, a selection of a photographic filter or a virtual lens;
deriving, via a model, a date, or a combination thereof, a music recommendation, a sound recommendation, or a combination thereof, for the selection of the photographic filter or the virtual lens; and
providing the music recommendation, the sound recommendation, or the combination thereof, to the client device.

19. The method of claim 18, wherein the model comprises a machine learning model trained to receive photographic filters and virtual lenses as input and provide as output one or more songs, song snippets, sounds, or a combination thereof.

20. A non-transitory computer-readable storage medium, the computer-readable storage medium including instructions that when executed by a computer, cause the computer to:
receive, from a client device, a selection of a photographic filter or a virtual lens;
derive, via a model, a date, or a combination thereof, a music recommendation, a sound recommendation, or a combination thereof, for the selection of the photographic filter or the virtual lens; and
provide the music recommendation, the sound recommendation, or the combination thereof, to the client device.
